(19) United States
(12) Patent Application Publication
(10) Pub. No.: US 2015/0369482 A1
(43) Pub. Date: Dec. 24, 2015

(54) Fueling Module

(71) Applicant: GAS TECHNOLOGY ENERGY CONCEPTS LLC, Buffalo,, NY (US)

(72) Inventor: David Reichard, Getzville, NY (US)

(21) Appl. No.: 14/763,938

(22) PCT Filed: Jan. 28, 2013
(86) PCT No.: PCT/US2013/023452

§ 371 Date: Jul. 28, 2015

(51) Int. Cl. F23K 5/00; B05B 7/20; H01M 8/04

(52) U.S. Cl. CPC F23K 5/007; H01M 8/04111; B05B 7/20

(57) ABSTRACT

A fueling module is described for supplying gaseous fuel to a torch, a thermal sprayer, a fuel cell, a thermal deburrer, or a fullerene-manufacture apparatus at an elevated pressure from a relatively low pressure gaseous fuel source such as a natural gas supply system. The fueling module also can include a selectively-operable alternate system for supplying such compressed gaseous fuel for other applications, including the recharging of one or more storage vessels. The fueling module includes features by which its gaseous fuel discharge pressure can be infinitely varied and preselectively adjusted within the capabilities of the fueling module's compressor device. The fueling module also includes features for cooling and filtering oil from a compressor to improve lifespan and enable operation of the fueling module at greater input gas pressures and greater output gas pressures under more strenuous operating conditions.

### BACKGROUND AND SUMMARY OF THE INVENTION

The invention relates generally to fuel cell apparatuses, thermal spray apparatuses, thermal deburring apparatuses, fullerene-manufacture apparatuses, and various torch or torch-like apparatus for cutting, welding, or heating operations involving either metallic or non-metallic materials. More specifically, the invention relates to a fueling apparatus for supplying fuel to such fuel cell apparatuses, thermal spray apparatuses, thermal deburring apparatuses, fullerene-manufacture apparatuses, and/or torch or torch-like apparatuses. As used herein, the general term “welding”, includes welding, brazing, or other known operations by which separate items or pieces of material are joined or fused to one another with the use of a flame-producing torch or burner.

A fuel cell is a device that converts a chemical energy into an electrical energy (i.e., electricity) through a chemical reaction with oxygen or another oxidizing agent. Hydrocarbons such as, for example, natural gas can be used as a fuel for some fuel cell apparatuses (e.g., solid oxide fuel cells). Such fuel cell apparatuses are generally configured to remove the carbon from the hydrocarbon, yielding a hydrogen source that can be utilized in the chemical reaction processes of the fuel cell to generate electrical energy.

Thermal spraying techniques are coating processes in which melted or heated materials are sprayed onto a surface. This process generally includes heating, by an electrical or chemical process, a feedstock (i.e., the coating precursor). Some types of thermal spraying utilize gaseous fuels such as, for example, natural gas (e.g., high velocity oxygen fuel spraying). Such processes generally require a relatively high pressure of gas fuel.

Thermal deburring is a procedure for removing internal and/or external burrs on machine parts, resulting from manufacturing processes such as, for example, milling or drilling processes. The machine parts are sealed in a pressurized chamber with a mixture of combustible gas (e.g., natural gas) and oxygen, which are ignited (e.g., via a spark plug) to thermally remove the burrs.

A fullerene is a molecule consisting entirely of carbon in the form of a hollow sphere, ellipsoid, or tube. A fullerene can be manufactured by a combustion-based process, utilizing a gaseous fuel such as, for example, natural gas at a suitable pressure within a fullerene-manufacture apparatus.

Various torches, burners, or other flame-producing devices are well-known for use in various operations, such as the welding, cutting or heating of various objects or various materials, including either metallic or non-metallic materials. Such torch or torch-like devices produce a flame upon the combustion of a mixture of air or other oxygen-containing gases with a suitable fuel. Typically, such suitable fuels include a variety of fuels such as propane, acetylene, natural gas, or other hydrocarbon gaseous fuels.

The fuels for use in the above-mentioned operations are generally provided in storage tanks or vessels that are connectable to the torch or the fuel cell apparatus. Because of the necessity for purchasing and transporting such fuels in pre-filled storage vessels, or for refilling and transporting previously-existing storage vessels, the provision of such fuels for the various operations described above is frequently very expensive and inconvenient in many applications. Furthermore, because of the differing operating pressures and other parameters associated with the above-mentioned operations, such fuels are frequently required to be supplied to the torch or torch-like apparatus, thermal spray apparatus, thermal deburring apparatus, fullerene-manufacture apparatus, or the fuel cell apparatus at different flow rates or at different pressures, thereby resulting in incompatibility or non-exchangeability of equipment among some of the above-mentioned operations.

It is therefore one of the primary objectives of the present invention to provide for a fueling apparatus or a module is adapted for use in supplying a fuel to a torch or torch-like apparatus, a thermal spray apparatus, a fuel cell apparatus, a thermal deburring apparatus, and/or a fullerene-manufacture apparatus from a convenient, readily-available, and inexpensive source of said fuel, such as natural gas, for example.

Another of the primary objectives of the present invention is to provide such a fueling apparatus or module capable of delivering a gaseous fuel, such as natural gas, at a wide variety of flow rates and pressures, thereby being compatible and interchangeable among a wide variety of welding, cutting or heating operations.

Still another objective of the present invention is to provide such a fueling apparatus or module capable of being connected to a relatively low pressure gaseous fuel supply source, such as a typical residential or commercial natural gas supply system.

A further objective of the present invention is to provide such a fueling apparatus or module that is relatively inexpensive, simple and convenient to use, relatively inexpensive to manufacture, and that is preferably portable in order to maximize its use in a wide variety of locations.

Another objective of the present invention is to provide such a fueling apparatus or module capable of fueling a torch or torch-like apparatus, a thermal spray apparatus, a fuel cell apparatus, a thermal deburring apparatus, and/or a fullerene-manufacture apparatus directly from a readily-available gaseous fuel source, as well as being usable for recharging pre-existing gaseous fuel storage tanks for subsequent use in remote locations where no gaseous fuel source is available.

According to the present invention, a fueling module is provided for supplying a gaseous fuel to a torch or other torch-like device at an elevated pressure from a relatively low pressure gaseous fuel source, such as a residential or commercial natural gas supply system, for example. An exemplary fueling module according to the present invention preferably includes an inlet readily connectable in fluid communication with the source of the gaseous fuel, a compressor for compressing gaseous fuel from the gaseous fuel source in order to increase its pressure, and a fueling module discharge selectively and releasably connectable to the torch for selectively supplying the compressed gaseous fuel thereto, including an adjustable regulator device for preselectively adjusting the pressure of the compressed gaseous fuel supplied to the torch. Preferably, the fueling module according to the present invention also includes a second, alternate fueling module discharge system for selectively bypassing the above-mentioned adjustable regulator device in order to discharge the compressed gaseous fuel directly from the compressor for purposes of recharging one or more gaseous fuel storage vessels, for example.

Various embodiments of the fueling module according to the present invention can include one or all of a variety of optional, but preferred, features, such as a filter for filtering the gaseous fuel between the fueling module inlet and the compressor intake, a lubricant filter for trapping and collecting compressor lubricants from the compressed gaseous fuel from the compressor discharge outlet, a return system for returning the compressor lubricants to the intake of the compressor, a cooling device for reducing the temperature of the compressed gaseous fuel from the compressor discharge outlet, or a selectively operable valve system for selectively discharging the compressed gaseous fuel either through the above-mentioned adjustable regulator device or substantially directly from the compressor. Other optional, but preferred, features include an adjustable pressure cut-off device for pre-setting the maximum compressor discharge pressure and an adjustable relief valve system for pre-setting the pressure limit on the above-mentioned adjustable regulator device.

Additional objects, advantages and features of the present invention will become apparent from the following description and appended claims, taken in conjunction with the accompanying drawings.

### BRIEF DESCRIPTION OF THE DRAWINGS

FIG. 1 is a perspective view of a gaseous fuel torch apparatus according to aspects of the present invention, including an exemplary fueling module connected for supplying a gaseous fuel to a torch device.

FIG. 2 is a perspective view similar to that of FIG. 1, but illustrating the exemplary fueling module of FIG. 1 connected for supplying gaseous fuel for recharging one or more gaseous fuel storage vessels.

FIG. 3 is a perspective view of the exemplary fueling module of FIG. 1, with portions of its housing removed to reveal many of the internal components thereof.

FIG. 4 is a schematic flow diagram of the exemplary refueling apparatus of FIG.

FIG. 5 is a perspective view of a gaseous thermal spray apparatus according to aspects of the present invention, including the exemplary fueling module of FIG. 1 connected for supplying a gaseous fuel to a thermal spray apparatus.

FIG. 6 is a perspective view of a gaseous fuel cell apparatus according to aspects of the present invention, including the exemplary fueling module of FIG. 1 connected for supplying a gaseous fuel to a fuel cell apparatus.

FIG. 7 is a perspective view of a gaseous fuel cell apparatus according to aspects of the present invention, including the exemplary fueling module of FIG. 1 connected for supplying a gaseous fuel to a thermal deburring apparatus.

FIG. 8 is a perspective view of a gaseous fuel cell apparatus according to aspects of the present invention, including the exemplary fueling module of FIG. 1 connected for supplying a gaseous fuel to a fullerene-manufacturing apparatus.

FIG. 9 is a schematic diagram of an exemplary oil cooler module according to aspects of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

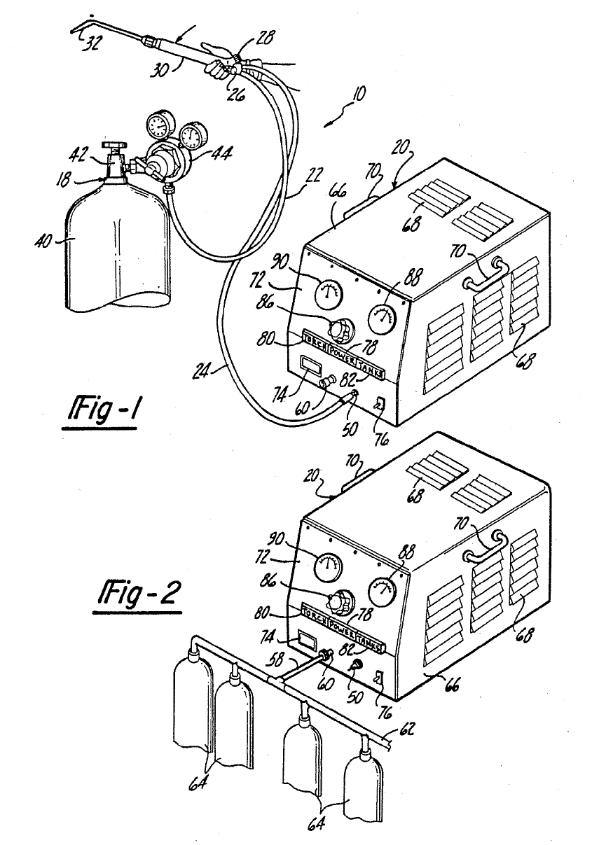

FIGS. 1 through 4 depict an exemplary embodiment of a gaseous fuel torch apparatus in accordance with the present invention, including an exemplary fueling module adapted for alternate use in supplying a gaseous fuel, such as natural gas for example, to a torch device, or for optionally recharging one or more gaseous fuel storage vessels or tanks. One skilled in the art will readily recognize from the following discussion and the accompanying drawings that the principles of the invention are equally applicable to torch apparatuses and fueling modules other than those shown for purposes of illustration in the drawings. It will also be readily apparent from the following discussion and the accompanying drawings that the present invention is adaptable to a wide variety of applications in addition to the torch supply and storage vessel supply applications shown for purposes of illustration in the drawings.

In FIG. 1, a gaseous fuel torch system 10 generally includes a torch assembly 16, an oxygen supply apparatus 18, and a fueling module 20, with an oxygen supply conduit 22 interconnecting the oxygen supply apparatus 18 with the torch assembly 16, and with a fuel supply conduit 24 interconnecting the fueling module 20 with the torch assembly 16. The torch assembly 16 shown in FIG. 1 is typical and representative of any of a wide variety of well-known torch assemblies commonly used in cutting, welding, or heating operations of various types. The torch assembly 16 generally includes an oxygen valve 26 and a fuel valve 28 for variably adjusting the fuel-and-oxygen mixture in a mixing portion 30 in order to produce a flame at a torch tip 32 upon combustion of the air-and-fuel mixture. Although not specifically shown in FIG. 1, the torch assembly 16 can preferably include a reducing regulator for fine-tuning of the fuel supply by the user of the torch.

Like the torch assembly 16, the oxygen supply apparatus 18 is typical and representative of any of a wide variety of well-known oxygen supply devices commonly used in cutting, welding, or heating operations. The oxygen supply apparatus 18 generally includes an oxygen tank 40, a shut-off valve 42, and an oxygen regulator device 44 for monitoring and adjusting the oxygen supply pressure and flow rate.

As shown in FIGS. 1 and 2, the fueling module 20 is adaptable for supplying a gaseous fuel to the torch assembly 16 through the fuel supply conduit 24, which is releasably connectable to the fueling module 20 by way of quick-connect torch discharge fitting 50, or alternately and selectively adaptable for other purposes such as that shown in FIG. 2. In FIG. 2, a recharging conduit 58 is releasably connectable to a quick-connect tank discharge fitting 60 for supplying gaseous fuel through a manifold 62 to one or more storage vessels 64. By such an arrangement, the fueling module 20 also has indirect utility in torch apparatus applications at remote locations where no electrical power source or gaseous fuel supply source is available, thereby allowing one or more of the storage vessels 64 to be recharged, transported, and used for gaseous fuel supply at such locations. It should be noted that the storage vessels 64 preferably contain a sorbent (adsorbent or absorbent) material in order to increase their gaseous fuel storage capacity. Examples of such storage tanks are disclosed in the above-mentioned United States Patents (incorporated by reference herein), and examples of the sorbent materials include activated carbon, zeolite materials, silica gel-type materials, or various clays.

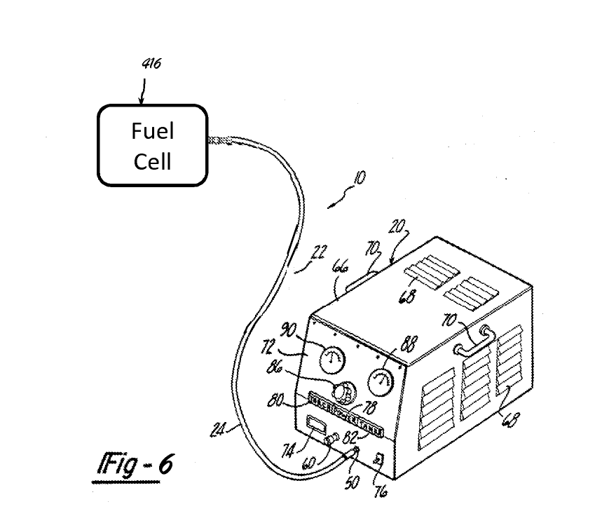

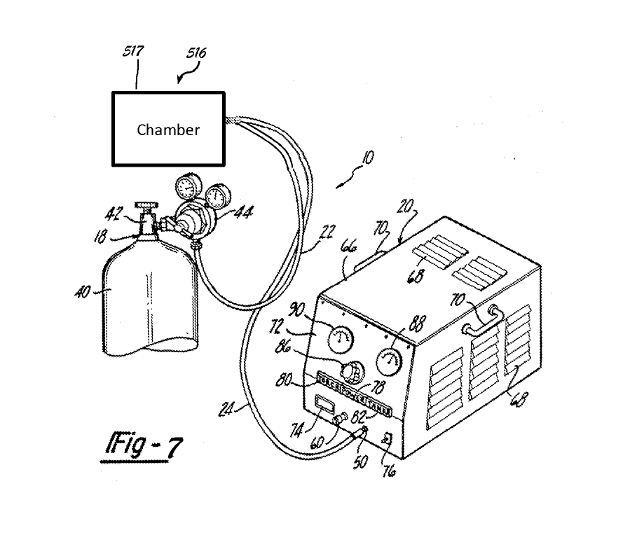

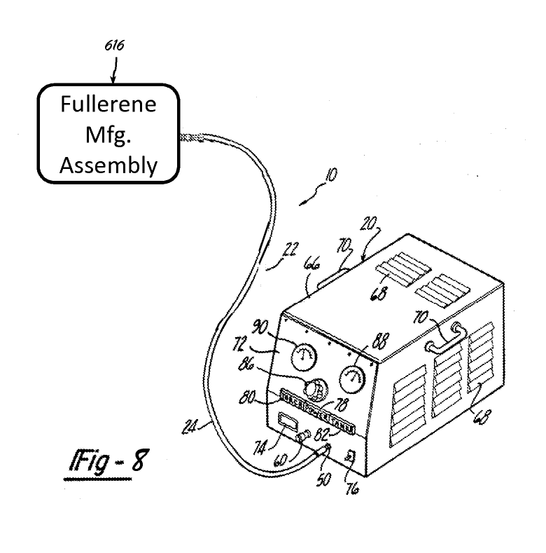

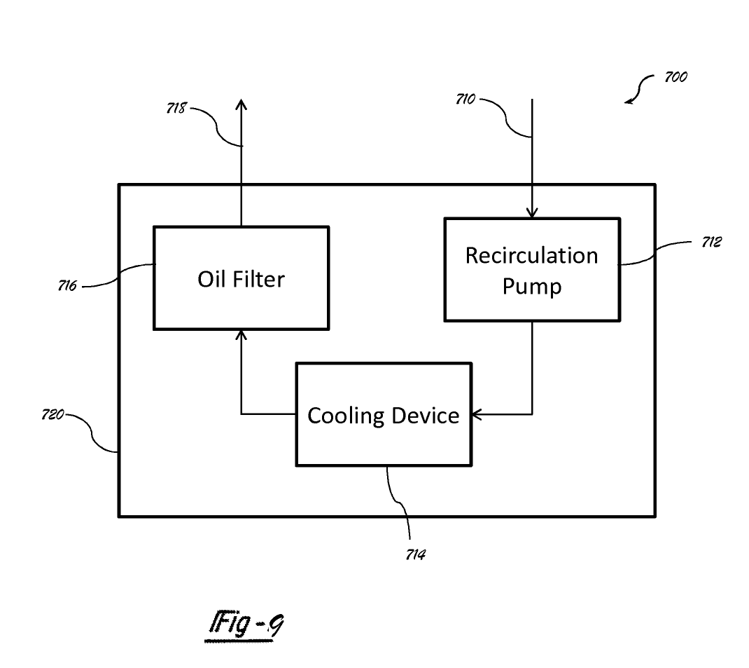

It should also be noted that the fueling module 20 can also be used for alternate gaseous fuel supply applications other than the torch application and the storage vessel recharging application shown for purposes of illustration in FIGS. 1-2. In particular, the fueling module 20 can be adaptable for supplying a gaseous fuel to a thermal sprayer assembly, a fuel cell assembly, a thermal deburring assembly, or a fullerene manufacture assembly through the fuel supply conduit 24 or the quick-connect tank discharge fitting 60. For example, FIG. 5 illustrates an exemplary thermal spray assembly 316 coupled to the fueling module 20 through the fuel supply conduit 24. Additionally, for example, the thermal spray assembly 316 can be connected to the oxygen supply 18 in a similar manner as described with respect to the torch assembly 16. The thermal spray assembly 316 can further include a feedstock fitting 330 for connecting the thermal spray assembly 316 to a feedstock or powder source (not shown). The thermal spray apparatus can also include a combustion chamber for receiving and combusting the natural gas and oxygen, and a combustion nozzle in communication with the combustion chamber for outputting a stream of hot gas. The feedstock fitting 330 facilitates the injection of feedstock, which is melted by the hot gas, and sprayed through a spray nozzle to apply the melted feedstock to a substrate. As another example, FIG. 6 illustrates an exemplary fuel cell apparatus 416 coupled to the fuel module 20 through the fuel supply conduit 24. The fuel cell apparatus 416 is configured to remove carbon from the gas supply, yielding a hydrogen source that can be utilized in the chemical reaction processes of the fuel cell 416 to generate electrical energy. As yet another example, FIG. 7 illustrates an exemplary thermal deburring assembly 516 coupled to the fuel module 20 through the fuel supply conduit 24 and the oxygen supply 18 through the conduit 22. The thermal deburring assembly 516 is configured to receive an object in a pressurized chamber 517 in which gaseous fuel from the fuel module 20 and oxygen from the oxygen supply 18 are mixed and ignited (e.g., via a spark plug) to remove one or more burrs from the object. In still another example, FIG. 8 illustrates an exemplary fullerene manufacture assembly 616 coupled to the fuel module 20 through the fuel supply conduit 24.

The fueling module 20 generally includes a housing 66 equipped with one or more ventilation louvers 68, one or more carrying handles 70, and a control panel 72. The control panel 72 includes a main power switch 74 for energizing and de-energizing the fueling module 20, and a selector switch 76 for preselecting any of the modes of operation shown in FIGS. 1, 2, 5, 6, 7 and 8. The control panel 72 also includes a power indicator light 78 for indicating to the user that the main power switch is in an “on” position, an indicator light 80 for indicating the selection of the torch application shown in FIG. 1, the thermal spray application shown in FIG. 5, the fuel cell application shown in FIG. 6, the thermal deburring application shown in FIG. 7 or the fullerene-manufacture application shown in FIG. 8, and a tank indicator light 82 for indicating the selection of the tank recharging or other such application shown in FIG. 2. A pressure regulator control 86 is also provided on the control panel 72 for allowing the user to selectively regulate the gaseous fuel supply pressure in the torch apparatus application shown in FIG. 1, the thermal spray assembly application shown in FIG. 5, the fuel cell assembly application shown in FIG. 6, the thermal deburring application shown in FIG. 7 or the fullerene-manufacture application shown in FIG. 8. A pressure gauge or indicator 88 is provided on the control panel 72 for monitoring the gaseous fuel discharge pressure in the torch mode, and a similar tank pressure gauge or indicator 90 is provided for monitoring the gaseous fuel discharge pressure in the mode of operation for recharging storage vessels or other such purposes.

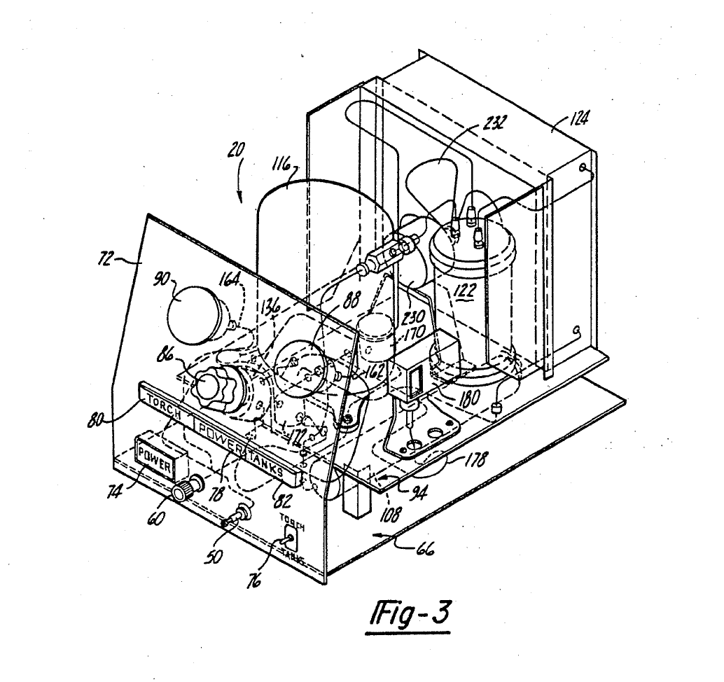

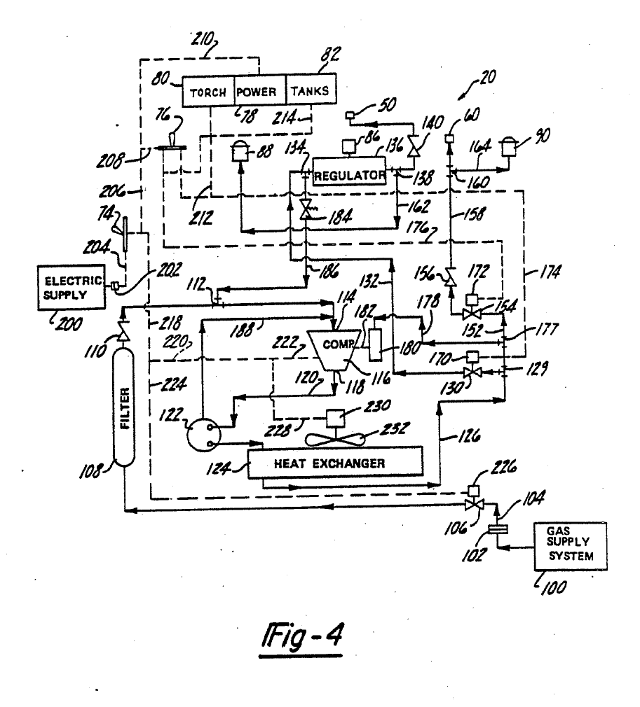

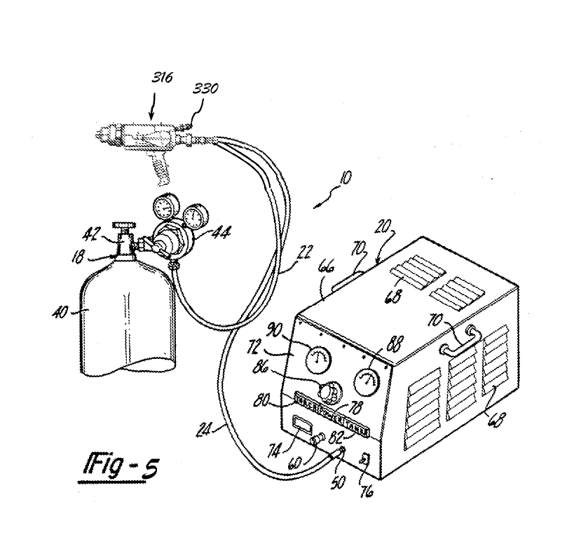

For clarity purposes and to simplify description of the internal components of the fueling module 20, the following description with respect to FIGS. 3-4 is provided in the context of a torch assembly 16 application shown in FIG. 1 and a storage vessel 64 application shown in FIG. 2; however, it should be understood that the description of the internal components and flow of gases through the fueling module 20 for FIGS. 3-4 is also applicable to the thermal spray assembly application shown in FIG. 5, the fuel cell application shown in FIG. 6, the thermal deburring application shown in FIG. 7 and the fullerene-manufacture application shown in FIG. 8 as well. Additionally, it should be understood that while the illustrated fueling module 20 includes two different modes of operation (e.g., a torch mode and a storage vessel mode), the fueling module 20 can alternatively include only one mode of operation (i.e., a torch mode, a thermal spray mode, a fuel cell mode, a thermal deburring mode, a fullerene-manufacture mode or a storage vessel mode).

Referring primarily to FIGS. 1 through 3, the various internal components of the fueling module 20 are contained within the housing 66 and are mounted or otherwise interconnected with a chassis structure 94. The housing 66 and the chassis 94 are preferably designed for providing suitable durability for the fueling module 20 consistent with its intended purposes. However, as is readily apparent to those skilled in the art, the various components and structural configurations of the fueling module 20 should be as light-weight and compact in size as is practicable in order to provide maximum transportability and thereby greatly add to the overall utility of the fueling module 20. In this regard, one early prototype of the fueling module 20 was constructed with overall approximate dimensions of 14 inches (35.6 cm) in width, 28 inches (71.1 cm) in depth, and 15.5 inches (39.4 cm) in height, and weighed approximately 75 pounds (34 kg) in weight. It is envisioned, however, that the overall dimensions and weight of commercial versions of the fueling module 20 can be significantly reduced, without significantly affecting the durability, quality, and utility of the fueling module 20.

Referring primarily to the schematic flow diagram of FIG. 4, but with additional reference to FIG. 3, the internal components, and the operation, of the fueling module 20 will now be described. The ultimate source of gaseous fuel for the fueling module 20 is a gaseous fuel supply system, indicated diagrammatically at reference numeral 100 in FIG. 4. The gaseous fuel supply system 100 can consist of virtually any readily-available source of gaseous fuel, but which most preferably consists of a typical natural gas supply system of the type commonly found in many residential or commercial installation. Such natural gas supply systems typically provide natural gas at pressures generally in the range of approximately ¼ psig (1.72 kPa) to approximately 10 psig (69 kPa), depending upon the location and supplier of the natural gas supply system, and upon whether such supply system is provided for residential or commercial use.

The fueling module 20 includes a quick-connect connector 102 for selectively and releasably connecting an inlet conduit 104 in fluid communication with the supply system 100. The inlet conduit 104 preferably includes a solenoid-operated inlet valve 106, a filter 108, and a one-way check valve 110. The filter 108 can comprise any of a number of known filter apparatuses suitable for use with the particular gaseous fuel being supplied, but preferably includes a dessicant filter for removing moisture or other undesirable materials from the gaseous fuel. Although various types of dessicant filters may be employed, one preferred dessicant filter 108 employs a sorbent (absorbent or adsorbent) material, such as an activated carbon, a zeolite material, a silica gel-type material, or various clays, for example.

The gaseous fuel, which preferably consists of natural gas, is supplied through the inlet conduit 104, a tee fitting 112, and the other components described above to a compressor intake 114 of a compressor device 116, which is selectively energizable for compressing the gaseous fuel in order to increase its pressure. In the actually-constructed prototype embodiment of the fueling module 20 described above, the compressor 116 was a hermetically-sealed gas compressor of the type commonly employed in refrigeration apparatuses. Such compressors are inexpensive, durable, and readily available as off-the-shelf items. One skilled in the art will readily recognize, of course, that other types of compressors may alternatively be used. Preferably, however, the compressor 116 compresses the gaseous fuel to a pressure generally in the range of approximately 100 psig (689 kPa) to approximately 500 psig (3450 kPa), depending upon the preselected parameters discussed below and the demands of the particular application.

The compressed gaseous fuel is forcibly conveyed from a compressor discharge 118 through a conduit 120 to a compressor lubricant separator 122. The lubricant separator 122 can comprise any of a number of known separator or filter-type devices adapted to remove lubricating oils or liquids from a gas stream passing therethrough. Preferably, the lubricant separator 122 is of the well-known gravity, capillary tube type and is adapted to return the collected compressor lubricants to the compressor intake 114 through a lubricant return conduit 188, under the motivating force of the compressor discharge gas pressure.

From the lubricant separator 122, the compressed gaseous fuel is preferably conveyed through a condenser or heat exchanger 124 for reducing the temperature of the compressed gaseous fuel. The heat exchanger 124 preferably comprises a cooling coil, over which ambient air is forced by a cooling fan 232. In the actually-constructed prototype embodiment of the refueling module 20 described above, the temperature of the gaseous fuel, which was natural gas, entering the heat exchanger 124 was approximately 140.degree. F. (60.degree. C.) and the natural gas temperature on the outlet of the heat exchanger 124 was substantially at ambient temperature. Although the heat exchanger 124 has been depicted in the drawings as comprising the air-to-gas cooling coil apparatus described above, one skilled in the art will readily recognize that other types of heat exchangers, condensers or other cooling apparatuses may alternately be employed to reduce the temperature of the compressed gaseous fuel from the compressor discharge 118 of the compressor 116.

From the heat exchanger 124, the compressed and cooled gaseous fuel is conveyed through a conduit 126 to a tee fitting 129, at which the compressed gaseous fuel can then be discharged from the fueling module 20 through either of two alternate fueling module discharge systems, as illustrated in FIGS. 1 and 2. In the first fueling module discharge system, the compressed gaseous fuel is conveyed from the tee fitting 129 through a preferably solenoid-operated torch valve 130, a first discharge conduit 132, and a tee fitting 134 to an adjustable regulator 136. The adjustable regulator 136 can comprise any of a number of commonly-available adjustable regulator devices operable for preselectively adjusting the pressure of a gas flowing therethrough. The adjustable regulator 136 is selectively operable by way of the above-mentioned pressure regulator control 86 on the control panel 72 in order to preselectively discharge gaseous fuel at a preselectively adjusted discharge pressure through the torch discharge fitting 50 by way of a one-way check valve 140.

The fueling module 20 also preferably includes an adjustable relief valve 184 connected, by way of the tee fitting 134, in fluid communication with the inlet side of the adjustable regulator 136 in order to allow the selected pre-setting of the pressure limit for the adjustable regulator device 136. Because the compressor 116 is typically a constant-speed, constant-output compressor, it discharges a substantially continuous and constant compressed gaseous fuel output whenever it is energized. Thus, any excess output capacity of the compressor 116 must be returned to the compressor intake 114 by way of the relief valve 184 and a gas return conduit 186, which is connected in fluid communication with the compressor intake 114 by way of the tee fitting 112.

Because of the adjustable relief valve arrangement discussed above, the fueling module 20 can be selectively pre-set, by way of adjustment of the relief valve 184, for a maximum gaseous fuel discharge pressure through the above-described first fueling module discharge system that cannot be exceeded by operation of the adjustable regulator device 136. The provision of the above features in the fueling module 20 thereby allows for an infinite preselected adjustment or variation of the fueling module discharge pressure for the torch mode of operation, with infinitely adjustable limits thereon, within the ranges of adjustability of the adjustable regulator device 136 and the relief valve 184, and within the maximum discharge capabilities of the compressor 116. In order to allow the fueling module user to monitor the pressure at which the gaseous fuel is supplied in the torch mode of operation, a tee fitting 138 is provided on the outlet side of the adjustable regulator device 136 in fluid communication, through a conduit 162, with the above-discussed torch pressure indicator 88.

While the above description relates to a “torch mode” of operation, the fuel module can be utilized in a similar fashion to connect and supply a modified gas source to a thermal sprayer assembly 316 (e.g., as shown in FIG. 5), a fuel cell assembly 416 (e.g., as shown in FIG. 6), a thermal deburring assembly 516 (e.g., as shown in FIG. 7), and/or a fullerene manufacture assembly 616 (e.g., as shown in FIG. 8). In such contexts, the “torch mode” can also be referred to as a “thermal sprayer mode” of operation, a “fuel cell mode” of operation, a “thermal deburring mode” of operation, or a “fullerene manufacture mode” of operation.

For the optional alternate mode of operation of the fueling module 20, such as for the storage vessel recharging shown for purposes of illustration in FIG. 2, the tee fitting 129 is also connected to a second fueling module discharge system by way of a second discharge conduit 152 and a preferably solenoid-operated tank valve 154. Compressed gaseous fuel in the second fueling module discharge system is conveyed directly from the tank valve 154, through a one-way check valve 156, a second discharge conduit 158, and a tee fitting 160, to the above-discussed tank discharge fitting 60. As is readily apparent in FIG. 4, the second fueling module discharge system supplies compressed gaseous fuel to the tank discharge fitting 60, without passing through the adjustable regulator device 136 of the first fueling module discharge system. This is because the discharge pressure in tank recharging is desired to be held below a pre-set maximum level in order to avoid overpressuring the tanks. In order to allow the operator to observe the pressure at which compressed gaseous fuel is discharged through the tank discharge fitting 60, thereby allowing the user to monitor the recharging operation for example, a conduit 164 is connected in fluid communication with the above-mentioned tee fitting 160 and with the above-mentioned tank pressure indicator 90 on the control panel 72.

In order to provide a pre-set maximum compressor discharge pressure, as well as providing for a fail safe feature in the event of a system malfunction, the fueling module 20 preferably also includes a tee fitting 177 in the second discharge conduit 152, which provides fluid communication by way of a compressor control conduit 178 to a pressure cut-off controller device 180. The pressure cut-off device 180 is preselectively and adjustably pre-settable for a maximum overall compressor discharge pressure and, as will be described in more detail below, is capable of de-energizing the compressor 116 by way of a control conduit 182 interconnecting the pressure cut-off 180 and the drive motor (not shown) of the compressor 116. The pressure cut-off device 180 can be adjustably pre-set in order to provide upper limits on the gaseous fuel discharge pressure through either of the fueling module discharge systems, as well as providing automatic shut-off of the compressor 116 in the event of down-stream conduit or hose ruptures, or various other malfunctions in which compressor de-energization is necessary or desirable. It is preferred that one the pressure cut-off controller 180 has de-energized the compressor 116, it can be reset to resume operations only by a manual resetting procedure in order to encourage the user to ascertain the cause of the compressor de-energization and correct any malfunctions prior to resuming operations.

In order to provide for the various functions and features described above, the fueling module 20 includes a power and control system, shown diagrammatically in FIG. 4, for energizing, de-energizing, and controlling the various components. The fueling module 20 is preferably electrically powered and is releasably connectable with a conventional external electrical power source 200 by way of a conventional electrical connector 202. Electrical energy is conveyed by way of an electrical supply line 204 to the above-described main power switch 74, which is selectively operable to either an “on” position or an “off” position.

When the main power switch 74 is in its “on” position, electrical energy is conducted by way of an electrical feed line 206 and a power indicator feed line 210 to the above-mentioned power indicator light 78 on the control panel 72, thereby providing indication to the operator that the fueling module 20 is energized. Electrical power is also supplied through the main power switch 74, the electrical feed line 206, and a selector switch feed line 208 to the above-mentioned selector switch 76 for purposes that will be described in more detail below. The main power switch 74 is also the vehicle for supplying electrical power by way of other electrical feed lines 218 and 220 and a compressor feed line 222 to the motor drive (not shown) for the compressor 116, thereby allowing the compressor 116 to be selectively energized and de-energized through the main power switch 74. The electrical feed line 218 also branches off into an inlet solenoid feed line 224 in order to energize an inlet solenoid operator 226 for purposes of opening the inlet valve 106 when the system is energized, or for closing the inlet valve 106 when the system is de-energized.

A fan motor feed line 228 is also provided for supplying electrical power from the main power switch 74 to the fan motor 230 of the heat exchanger fan 232. Thus, the operator 116, the fan motor 230 and the fan 232, and the solenoid-operated inlet valve 106 are all energized and de-energized, along with the selector switch 76 and the power indicator light 78, by way of operation of the main power switch 74.

Once the fueling module 20 has been energized so that the selector switch 76 is energized, the selector switch 76 can be selectively operated to the so-called “torch” position in order to energize the first solenoid operator 170 on the torch valve 130, by way of a first electrical control line 174. Similarly, if the selector switch 76 is moved to the so-called “tank” position, a second solenoid operator 172 is energized by way of a second electrical control line 176 for purposes of opening the above-mentioned solenoid-operated tank valve 154. Therefore, when the selector switch 76 is moved to the so-called “torch” position, the solenoid operator 170 is energized to open the torch valve 130, and substantially simultaneously, the solenoid operator 172 is de-energized so as to close the tank valve 154. Conversely, when the selector switch is moved to the so-called “tank” position, the solenoid operator 172 is energized to open the tank valve 154, and substantially simultaneously, the solenoid operator 170 is de-energized to close the torch valve 130. By such an arrangement, the fueling module 20 can be employed for discharging compressed gaseous fuel, preferably natural gas, either through the first fueling module discharge system for purposes of tank operation, or through the second fueling module discharge system for purposes of storage vessel recharging or other such applications.

In order to provide the user with an indication of whether the “torch” or “tank” mode has been selected, an electrical torch indicator feed line 214 is electrically interconnected to provide power from the first electrical control line 174 to the torch indicator light 80. Similarly, an electrical tank indicator feed line 212 supplies electrical power between the second electrical control line 176 and the tank indicator light 82.

The operation of the fueling module 20 can be briefly and generally described by starting with the appropriate interconnection of the fueling module 20 for the desired mode of operation either for the torch assembly 16, as shown in FIG. 1, or for the storage vessels 64, as shown in FIG. 2. The fueling module 20 can then be interconnected with the gaseous fuel supply system 100 by way of the quick-connect connector 102, followed by electrical interconnection with the electrical power source 200 by way of the electrical connector 202.

When the main power switch 74 is moved to its “on” position, the power indicator light 78, the selector switch 76, the compressor 116, the fan motor 230, and the inlet solenoid operator 226 are all energized in order to open fluid communication with the gaseous fuel supply system 100 and to start the fueling module 20. Depending upon which position of the selector switch 76 has been selected, the appropriate torch indicator light 80, or the tank indicator light 82, is also energized and illuminated.

When the main power switch 74 has been moved to its “on” position, and the selector switch 76 is moved to the “torch” mode position, the torch valve 130 is opened, and the tank valve 154 is simultaneously closed. This condition allows the compressed gaseous fuel to be supplied through the first fueling module discharge system to the torch assembly 16, with the discharge pressure being selectively adjusted and controlled by the adjustable regulator 136 and its torch pressure regulator control 86. Such discharge pressure regulation can be accomplished within the pre-set limits imposed on the first fueling module discharge system by the preferably manually adjustable relief valve 184, as described above.

Similarly, when the selector switch 76 is moved to the “tank” position, the tank valve 154 is opened, and the torch valve 130 is substantially simultaneously closed, in order to discharge compressed gaseous fuel through the second fueling module discharge system substantially directly to the storage vessel 64 or for other fuel-using applications. As mentioned above, the fueling module discharge pressure in either of the above-described modes of operation is ultimately governed by the selectively pre-set maximum compressor discharge pressure setting of the preferably manually adjustable pressure cut-off device 180.

Conversely, when the main power switch 74 is moved to its “off” position, the above-described components are de-energized in order to shut down the entire fueling module 20. In this regard, it should be noted that remains in the fueling module 20 due to the fact that there is no provision for internal storage of compressed natural gas. This feature significantly adds to the safety of the fueling module 20 by substantially avoiding the build-up of pressurized gaseous fuel therein during periods of non-use.

In order to provide examples of suitable components for the exemplary fueling module 20, a chart is set forth below, wherein many of the major components of the fueling module 20 are identified either generically or by supplier or other relevant product information, accompanied by appropriate trade names or trademarks where applicable. It should be emphasized that the information provided below is merely exemplary, and that one skilled in the art will readily recognize that a wide variety of equivalent or alternate components may also be employed.

| Component | |
|---|---|
| Reference Numeral | Description |
| 50 | Brass CGA Hose Adapter/Fitting |
| 60 | “Swagelok” SS-QC4-B-4PF Female, Single End, |
| | Shut-Off Quick-Connector |
| 76 | 15 Amp, 115 V, DPDT Selector Switch |
| 88 | “Wika” 111.10, 2½ Inch, 0-30 Psi, CBM/U-C |
| | Pressure Gauge |
| 106 | “Wika” 111.10, 2½ Inch, 0-400 Psi, CBM/U-C |
| | Pressure Gauge |
| 108 | Dessicant-filled Moisture Separator/Filter |
| | Assembly |
| 116 | “Copeland” JRL4-0050-IAA Welded Hermetic |
| | Compressor |
| 122 | “AC&R Components” S-5580 Oil Separator |
| 124 | Heat Exchanger, Double Row, 575 Psig, W.P. |
| 130 | “Valcor” SV-12, Normally Closed Solenoid Value, |
| | Value, ¼ Inch Port Diameter, 115 V., 60 Hz. |
| 136 | “Tescom” Hand-Loaded Pressure Reducing |
| | Regulator, 0-50 Psig Outlet |
| 140 | “Nupro” 4CP In-line Check Valve |
| 184 | “Nupro” 4CPA Adjustable In-Line Relief Valve |
| 230 | “Steveco” Fan Motor Assembly 9W-COW, 115 |
| | V., 60 Hz. |

As explained above, the fueling module 20 can be utilized for alternate gaseous fuel supply applications such as, for example, a thermal sprayer assembly 316 (e.g., as shown in FIG. 5) and/or a fuel cell assembly 416 (e.g., as shown in FIG. 6). Some gaseous fuel supply applications involve relatively high pressure outputs of the gaseous fuels. For example, a thermal sprayer assembly 316 may require gaseous fuel up to approximately 150 psig (1135.54 kPa) or greater. Other gaseous fuel supply applications may require a relatively high pressure inputs of the gaseous fuels into the fueling module 20 (e.g., greater than approximately 10 psig (170.27 kPa). Still other gaseous fuel supply application may require that the fueling module 20 to continuous run for a relatively long period of time. It has been discovered that when the fueling module 20 is operated to provide the gaseous fuel at a relatively high output pressure, receives gas from a source at relative high pressure (e.g., in the range of approximately 10 psig (170.27 kPa) to approximately 15 psig (204.75 kPa)) or the fueling module 20 is continuous run for a relatively long period of time, the fueling module 20 may generate excessive heat. Under such circumstances, the fueling module 20 can either become damaged or, if a thermal protection device (e.g., a circuit breaker or a relief valve) is utilized, the fueling module 20 may cease to operate until the fueling module 20 cools.

To address such problems, an oil cooler module 700 can be provided to extract, cool, filter, and return the oil for the compressor 116. Referring to FIG. 9, a block diagram of an exemplary oil cooler module 700 is illustrated. The oil cooler module 700 includes an oil input 710, a recirculation pump 712, a cooling device 714, an oil filter 716, and an oil output 718. The recirculation pump 712 is configured to extract oil from the compressor 116, causing the oil to pass to the cooling device 714 via the oil input 710. The cooling device 714 can include any device that is suitable to reduce the temperature of the oil. As non-limiting examples, the cooling device can include a cooling radiator, a Peltier device, a water-based system, a cooling fan, combinations thereof, and/or the like. Thus, as the oil passes through the cooling device 714, the temperature of the oil is reduced. The oil is directed from the cooling device 714 to an oil filter 716. The oil filter 716 is configured to clean the oil by capturing contaminants that can harm the compressor 116. The cooled and filtered oil is then returned from the oil filter 716 to the compressor 116 via the oil output 718.

According to some embodiments, the oil cooler module 700 can be disposed within the housing 66 of the fueling module 20. According to other embodiments, the oil cooler module 700 can be disposed in a different housing 720 that is separate and distinct from the housing 66 of the fueling module 20. In the embodiments in which a distinct housing 720 is provided, it is contemplated that the oil input 710 and the oil output 718 of the oil cooler module 700 can comprise valves or fittings externally disposed on the housing 720 of the oil cooler module 700 such that a hose (or other like device) can be coupled to the valves or fittings on the cooler module 700 and to similar valves or fittings externally disposed on the housing 66 of the fueling module 20.

Advantageously, when the fueling module 20 is operated in conjunction with the oil cooler module 700, the lifespan of the compressor 116 is extended due to the improved temperature control and filtering. Additionally, as explained above, by reducing the temperature of the oil, the compressor 116 can be operated at a reduced temperature, which permits more rigorous operation of the fueling module 20. More particularly, the oil cooler module 700 allows the fueling module 20 to be operated at greater input/output gas pressures and for greater continuous periods of time (than if the oil cooler module were omitted). For example, the fueling module 20 may not be able to effectively operate with a natural gas source supplying the natural gas at a pressure of approximately 15 psig (204.75 kPa) without the oil cooler module such as the oil cooler module 700 described herein.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A system for supplying natural gas from a natural gas supply system to a thermal spray apparatus, said natural gas supply system being operable to provide a natural gas at a low pressure, the system comprising:
a system inlet configured to be coupled in gaseous communication with said natural gas supply system;
a compressor coupled in gaseous communication with the system inlet and selectively energizable for compressing said natural gas from said natural gas supply system to increase the pressure of said natural gas, said compressor having a compressor intake in fluid communication with said system inlet and a compressor outlet configured to discharge compressed natural gas from said compressor;
a lubricant separator coupled in communication with said compressor outlet configured to collect a lubricant from said compressed natural gas from said compressor outlet and return said collected lubricant to said compressor intake;
a heat exchanger in gaseous communication with said compressor outlet configured to reduce the temperature of said compressed natural gas received from said compressor outlet;
a system outlet in gaseous communication with said heat exchanger and configured to be coupled in gaseous communication with said thermal spray apparatus so as to provide said thermal spray apparatus with said compressed natural gas; and
a oil cooling module configured to extract an oil from said compressor, cool said oil, filter said oil, and return said oil to said compressor.

2. The system of claim 1, further comprising an adjustable regulator assembly in gaseous communication with said heat exchanger and said system outlet, said adjustable regulator being configured to control the amount said pressure of said natural gas is increased such that said natural gas has a preselectively adjusted discharge pressure.

3. The system of any one of claims 1-2, wherein said oil cooling module comprises:
an oil intake in fluid communication with said compressor for receiving said oil from said compressor;
a pump in fluid communication with said oil intake, said pump being configured to extract said oil from said compressor;
an oil cooling device in fluid communication with said pump, said oil cooling device being configured to reduce the temperature of said oil;
an oil filter in fluid communication with said cooling device, said oil filter being configured to remove one or more contaminants from said oil; and
an oil outlet in fluid communication with said oil filter and further in fluid communication with said compressor for return of said oil to said compressor.

4. The system of claim 3, wherein said oil cooling device is a radiator.

5. The system of any one of claims 1-4, further comprising a housing and wherein at least said compressor, said lubricant separator, and said heat exchanger are disposed within said housing.

6. The system of claim 5, wherein said oil cooling module is also disposed in said housing.

7. The system of claim 5, further comprising an additional housing that is separate from said housing and wherein said oil cooling module is disposed within said additional housing.

8. The system of any one of claims 1-7, further comprising a cut-off controller device configured to preselectively and adjustably preselected a maximum compressor discharge pressure and automatically de-energize said compressor when the natural gas from said compressor outlet reaches said preselected maximum compression discharge pressure.

9. The system of claim 8, further comprising a preselectively adjustable relief valve for returning a portion of said natural gas from said system outlet to said compressor intake when the pressure of said natural gas in said system outlet reaches a preselected relief pressure level, said preselectively adjusted discharge pressure being substantially limited to a pressure level no greater than said preselected relief pressure and no greater than said preselected maximum compression discharge pressure.

10. The system of any one of claims 1-9, further comprising said thermal spray apparatus, wherein said thermal spray apparatus includes:
an source of oxygen configured to supply oxygen;
a combustion chamber configured to receive and combust said natural gas at said preselectively adjusted discharge pressure and said oxygen;
a combustion nozzle in communication with said combustion chamber and configured to output a stream of hot gas;
a feedstock supply configured to inject a powder feed stock into said stream of hot gas for melting; and
a spray nozzle configured to apply the melted feed stock on a substrate.

11. A fueling system for alternatively supplying natural gas to a fuel cell and at least one storage vessel, said natural gas supply system being operable to provide a natural gas at a low pressure, the system comprising, said fueling system comprising:
a system inlet configured to be coupled with said natural gas supply system;
a compressor in communication with said system inlet and selectively energizable for compressing said natural gas from said natural gas supply system to increase its pressure, said compressor having a compressor intake in fluid communication with said system inlet and a compressor outlet for discharging compressed natural gas from said compressor;
a lubricant filter in communication with said compressor outlet for substantially trapping and collecting lubricants from said compressed natural gas from said compressor outlet and for returning said collected lubricants to said compressor intake;
a heat exchanger in communication with said compressor outlet for reducing the temperature of said compressed natural gas therefrom;
a first system outlet selectively and releasably connectable to the fuel cell for selectively supplying said compressed natural gas from said compressor to said fuel cell, said first system outlet including an adjustable regulator in communication with said compressor outlet and operable for preselectively adjusting the pressure of said compressed natural gas from said compressor to supply said compressed natural gas to the fuel cell at a preselectively adjusted fueling module discharge pressure;
a second system outlet in communication with said compressor outlet selectively and releasably connectable to the storage vessel for selectively bypassing said adjustable regulator and for selectively supplying said compressed natural gas from said compressor to the storage vessel without passing said compressed natural gas through said adjustable regulator;
one or more valves for selectively discharging said compressed natural gas from said compressor through one of said first system outlet and second system outlet, said one or more valves including at least one electric solenoid-operated valve in each of said first and second system outlets, and a selector switch selectively energizable and operable for operating said solenoid valves to substantially simultaneously open either one of said solenoid-operated valves while closing the other of said solenoid-operated valves in order to selectively discharge said compressed natural gas through the corresponding one of said first and second system outlets;
a preselectively adjustable cut-off controller for automatically de-energizing said compressor when the natural gas from said compressor outlet reaches a preselected maximum compression discharge pressure; and
a preselectively adjustable relief valve for returning a portion of said natural gas from said first system outlet to said compressor intake when the pressure of said natural gas in said first system outlet reaches a preselected relief pressure level, said preselectively adjusted fueling system discharge pressure being substantially limited to a pressure level no greater than said preselected relief pressure and no greater than said preselected maximum compression discharge pressure.

12. The system according to claim 11, further comprising a oil cooling module configured to extract an oil from said compressor, cool said oil, filter said oil, and return said oil to said compressor.

13. The system of claim 12, wherein said oil cooling module comprises:
an oil intake in fluid communication with said compressor for receiving said oil from said compressor;
a pump in fluid communication with said oil intake, said pump being configured to extract said oil from said compressor;
an oil cooling device in fluid communication with said pump, said oil cooling device being configured to reduce the temperature of said oil;
an oil filter in fluid communication with said cooling device, said oil filter being configured to remove one or more contaminants from said oil; and
an oil outlet in fluid communication with said oil filter and further in fluid communication with said compressor for return of said oil to said compressor.

14. The system according to any one of claims 1-13, wherein said preselectively adjusted discharge pressure is greater than or equal to approximately 150 psi.

15. The system according to any one of claims 1-14, wherein said natural gas in said natural gas supply is at a pressure generally in the range of approximately ¼ psig (1.72 kPa) to approximately 15 psig (204.75 kPa), said compressor increasing the pressure of said natural gas to a pressure less than approximately 500 psig (3450 kPa).

16. The system according to claim 15, wherein said natural gas in said natural gas supply is at a pressure generally in the range of approximately 10 psig (170.27 kPa) to approximately 15 psig (204.75 kPa).

17. The system according to any one of claims 1-16, further comprising a thermal deburring apparatus.

18. The system according to claim 17, further comprising an oxygen supply coupled to the thermal deburring apparatus, the thermal deburring apparatus further being coupled to the first system outlet, the thermal deburring apparatus including a sealed chamber configured to be pressurized and to receive an object having at least one burr.

19. The system according to any one of claims 1-17, further comprising a fullerene-manufacture apparatus coupled to the first system outlet and configured to manufacture one or more fullerene molecules via a combustion process.
